(19) United States
(12) Patent Application Publication
(10) Pub. No.: US 2014/0136868 A1
(43) Pub. Date: May 15, 2014

(54) POWER SAVING METHOD AND HANDHELD ELECTRONIC DEVICE USING THE SAME

(71) Applicant: ASKEY COMPUTER CORP., New Taipei City (TW)

(72) Inventors: Yi-Hsin Lee, Taichung City (TW); Teh-Shen Lee, Taipei City (TW)

(73) Assignee: ASKEY COMPUTER CORP., NEW TAIPEI CITY (TW)

(21) Appl. No.: 13/740,264

(22) Filed: Jan. 14, 2013

(30) Foreign Application Priority Data
Nov. 9, 2012 (TW) 101141855

(51) Int. Cl. G06F 1/32

(52) U.S. Cl. CPC G06F 1/324
USPC 713/322

(57) ABSTRACT

A power saving method and a handheld electronic device using the same are provided. The method includes the following steps. A trigger signal is received. An user interface is displayed in a touch display panel unit of the handheld electronic device, wherein the user interface includes at least one control item and the at least one control item respectively corresponds to at least one working mode of the handheld electronic device. An operating signal corresponding to one of the at least one control item is received from the touch display panel unit. The working mode of the handheld electronic device is switched according to the operating signal and a working frequency of the handheld electronic device is adjusted according to the working mode.

### CROSS-REFERENCE TO RELATED APPLICATION

This application claims the priority benefit of Taiwan application serial no. 101141855, filed on Nov. 9, 2012. The entirety of the above-mentioned patent application is hereby incorporated by reference herein and made a part of this specification.

### BACKGROUND

1. Field of the Invention

The invention relates to an electronic device. More particularly, the invention relates to a handheld electronic device and a power saving method thereof.

2. Description of Related Art

In recent years, handheld electronic device such as smart phones, tablet PCs and the like are extensively used by people. As the technology advances, performance of the handheld electronic device is further enhanced continuously, and external shapes of the handheld electronic device are developed to be lighter, thinner and more compact. An issue accompanied with enhanced performance is the increasing of power consumption. However, with volumes of handheld electronic devices being reduced, the handheld electronic devices do not have more spaces for a bigger battery, which means a power storage is also very limited. With the aforementioned two factors, a solution is urgently explored for an issue of maintaining both performance and desirable external shapes of a handheld electronic device, and reaches the best use of power.

### SUMMARY OF THE INVENTION

The invention provides a power saving method and a handheld electronic device for a user to adjust a working frequency of the handheld electronic device based on the current usage.

The invention provides a power saving method for a handheld electronic device, including the following steps. First, a trigger signal is received. Then, an user interface is displayed in a touch display panel unit of the handheld electronic device, wherein the user interface includes at least one control item and the at least one control item respectively corresponds to at least one working modes of the handheld electronic device. Next, an operating signal corresponding to one of the at least one control item is received from the touch display panel unit. Moreover, the working mode of the handheld electronic device is switched according to the operating signal and a working frequency of the handheld electronic device is adjusted according to the working mode.

The invention provides a handheld electronic device including a processor and a touch display panel unit. The processor receives a trigger signal. An user interface is displayed in the touch display panel unit, wherein the user interface includes at least one control item and the at least one control item respectively corresponds to at least one working mode of the handheld electronic device. Herewith, the processor receives an operating signal corresponding to one of the at least one control item from the touch display panel unit, the processor switches the working mode of the handheld device according to the operating signal, and adjusts a working frequency of the handheld electronic device according to the working mode.

In summary, the invention provides a power saving method and a handheld electronic device using the same, such that a user can choose a suitable working mode for the current situation through the touch display panel unit according to a current state of using the handheld electronic device to reach effects of power saving.

In order to make the aforementioned and other features and advantages of the invention more comprehensible, embodiments accompanying figures are described in details below.

### BRIEF DESCRIPTION OF THE DRAWINGS

FIG. 1 is a flow chart illustrating a power saving method according to one embodiment of the invention.

FIG. 2 is a block diagram of illustrating a handheld electronic device according to one embodiment of the invention.

FIG. 3 is a block diagram illustrating a handheld electronic device according to one embodiment of the invention.

FIGS. 4A and 4B are schematic diagrams illustrating an user interface according to one embodiment of the invention.

FIG. 5 is a flowchart illustrating a power saving method according to one embodiment of the invention.

### DESCRIPTION OF EMBODIMENTS

Handheld electronic devices are devices such as smart phones, tablet PCs and notebooks. Take a smart phone as an example, in the past, an average clock frequency of a processor in a smart phone ranges approximately from 500 M Hertz to 600 M Hertz and such clock frequency is approximately in accordance with a processing speed when operating general application programs such as browsing web pages, playing music and the like, on a smart phone. In terms of the current development, an average clock frequency of a processor is faster than 1 G Hertz. In the meantime, the processor may include more than one processing core, which is not only capable of more complicated computing operations and also capable of processing multiple data or application programs simultaneously.

However, in this situation, when high speed computing for complicated applications such as games is required, it is not required for a user to browse web pages or play music and the like, while the processor of the handheld electronic device is still operating with high clock frequency. Accordingly, it is a waste of power consumption. Therefore, in order to solve the aforementioned issue, the invention provides a power saving method and a handheld electronic device using the same, accompanied with the figures for detailed description.

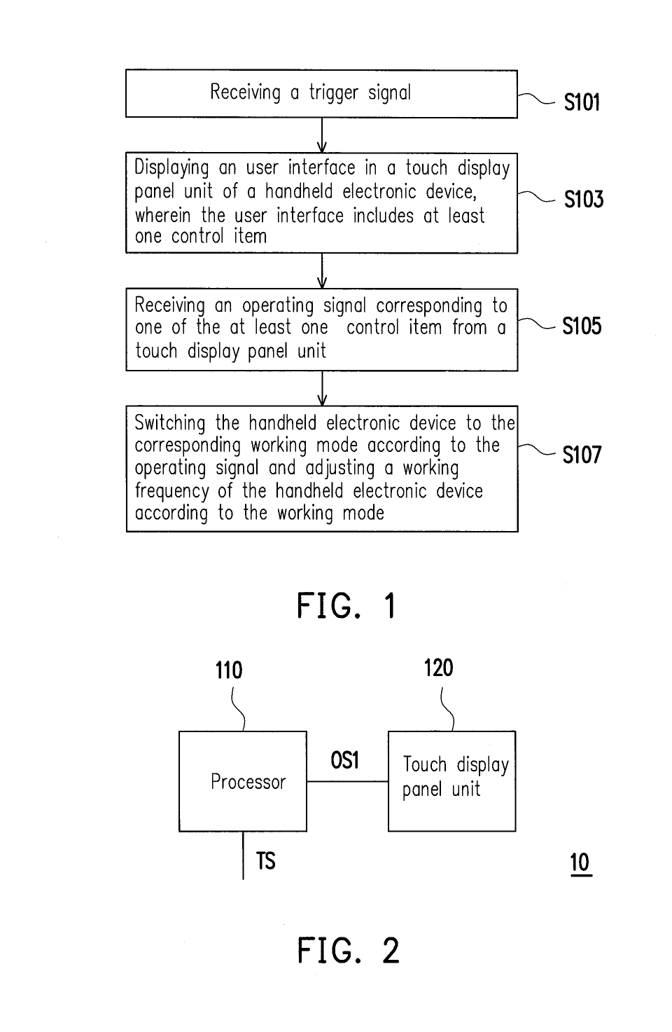

FIG. 1 is a flowchart illustrating a power saving method according to one embodiment of the invention. Referring to FIG. 1, first, in Step S101, a trigger signal is received. Next, in Step S103, an user interface is displayed in a touch display panel unit of a handheld electronic device, wherein the user interface includes at least one control item, and the at least one control item corresponds to at least one working mode of the handheld electronic device, respectively. Then, in Step S105, an operating signal corresponds to one of the at least one control item from the touch display panel unit. Next, in Step S107, the working mode of the handheld electronic device is switched according to the operating signal and a working frequency of the handheld electronic device is adjusted according to the working mode.

FIG. 2 is a block diagram of illustrating a handheld electronic device according to one embodiment of the invention. Referring to FIG. 2, a handheld electronic device 20 includes a processor 110 and a touch display panel unit 120. The processor 110 receives a trigger signal TS. The touch display panel unit 120 displays an user interface, wherein the user interface includes at least one control item and the at least one control item respectively corresponds to at least one working mode of a handheld electronic device 10. The processor 110 receives an operating signal OS1 corresponding to one of the at least one control item from the touch display panel unit 120, switches the working mode of the handheld electronic device 10 according to the operating signal OS1 and adjusts a working frequency of the handheld electronic device 10 according to the working mode.

It should be stated that the touch display panel unit 120 can be a display panel having a touch-control function and the touch display panel unit 120 can display an user interface including at least one control item, which means, each of the control items is displayed in a corresponding display region in the display panel of the touch display panel unit 120, wherein the display regions are also the touch display regions corresponding to the control items respectively. A signal is generated by the touch display panel unit 120 when the user touches a display region corresponding to one of the control items, and as a result, this signal is the operating signal OS1 that corresponds to the control item. As for a generating method of the operating signal OS1, it can be different according to implementations of the touch-control display unit 120. For example, the generating method of the operating signal OS1 can be generated by changes in capacitance value or resistance value of the touch display region touched by the user and such implementations can be implemented by people having ordinary skill in the art.

In the present embodiment, the working mode includes a high performance mode, a multimedia mode and a power saving mode correspond, respectively, to three different levels of working frequency from high to low of the handheld electronic device 10. For example, in the high performance mode, there is no limitation toward processing speed of a processor of the handheld electronic device 10. Therefore, when a user wants to execute a more complicated application program such as computing operations of a more complicated game, the user can switch working mode of the handheld device 10 to this working mode, i.e. the high performance mode.

In the multimedia mode, the highest computing speed (i.e. the highest clock frequency) of the processor 110 is limited under a first limit value, such that the processor 110 is set to perform normal operations such as watch video or play music, but cannot perform computing operations that are too complicated. In a power saving mode, the highest computing speed of the processor 110 is further limited under a second limit value which is lower than the first limit value, such that the processor 110 can complete simple computing operations while reducing power consumption.

When the processor 110 includes more than one processing core as mentioned above, the processor can also correspondingly turn off a certain amount of computing cores when switching to the multimedia mode or the power saving mode so as to further reduce power consumption. As for amounts of computing cores that can be turned off, it depends on practical implementing situations, but the invention is not limited thereto.

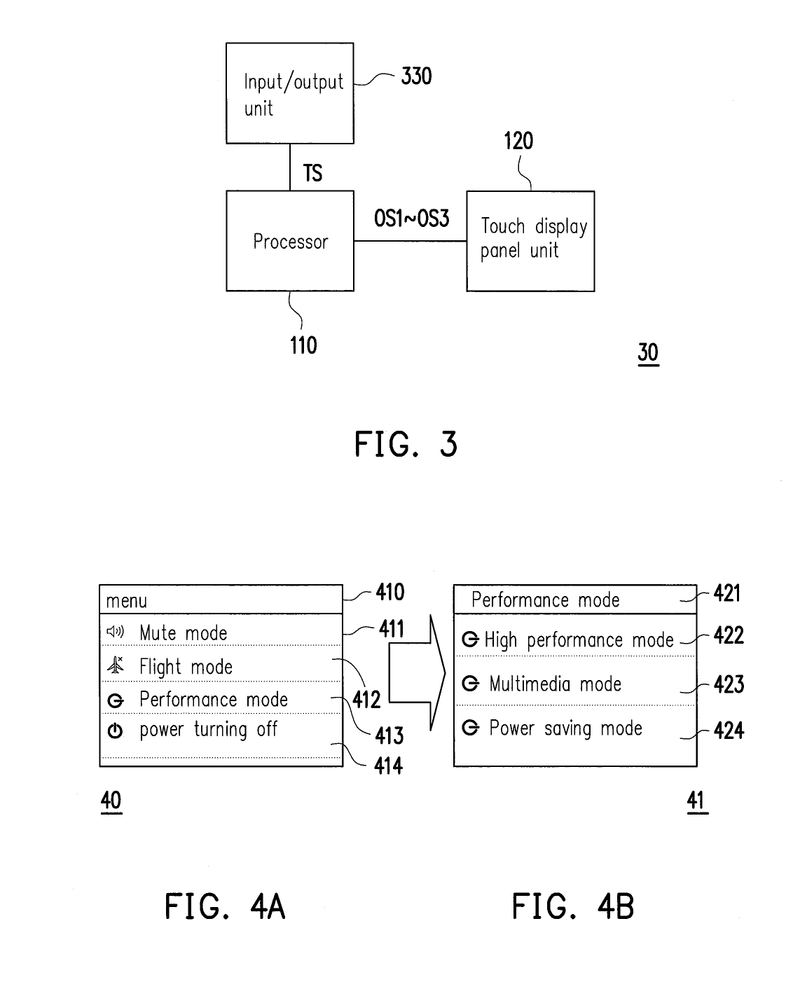

FIG. 3 is a block diagram of illustrating a handheld electronic device according to one embodiment of the invention. Referring to FIG. 3, the difference between the present embodiment of FIG. 3 and the embodiment of the aforementioned FIG. 2 is that, in the present embodiment of FIG. 3, a handheld electronic device 30 further includes an input/output unit 330, wherein the input/output unit 330 is coupled to the processor 110 and the processor 110 receives the trigger signal TS from the input/output unit 330.

In one implementation of the present embodiment, the input/output unit 330 includes a physical button. When the physical button is pressed for longer than a preset period of time, the input/output unit 330 then delivers the trigger signal TS to the processor 110. In the present embodiment, the preset period of time is set as 1 second. In other words, when a user presses the physical button for longer than 1 second, the aforementioned control items are displayed in the touch display panel unit 120, and the physical button can be any physical button such as a power button, return-to-main-menu button (home button), volume button, depending on practically implementing situations.

In another implementation of the present embodiment, the input/output unit 330 includes a microphone. When the microphone receives a specific audio signal, the input/output unit 330 also transmit a trigger signal TS to the processor 110. Generally speaking, the trigger signal TS is used to deliver a user request of switching working mode to the processor 110, such that control items can be displayed in the touch display panel unit 120.

The trigger signal TS can be generated via various ways, but the invention is not limited thereto. For example, in another embodiment of the invention, when the touch display panel unit 120 receives an operating signal OS2 corresponding to a request to display the at least one control item, the touch display panel unit 120 then transmits the operating signal OS2 to the processor 110. When the processor 110 receives the operating signal OS2, the control item is then displayed in the touch display panel unit 120. In other words, at this moment, the operating signal OS2 equals to the trigger signal TS.

On the other hand, in the present embodiment, at least one of control items can be integrated into a menu displayed in the touch display panel unit 120. The control items corresponding to the working modes of a handheld electronic device can also integrate with control items of other functions. For example, FIG. 4A and FIG. 4B are schematic diagrams showing a user interface according to one embodiment of the invention. Referring to FIG. 3, FIG. 4A and 4B, when the processor 110 receives the trigger signal TS (i.e. when a user presses the power button for a long time), the processor 110 then controls touch display panel unit 120 to display menu 40 in the touch display panel unit 120 as shown in FIG. 4A.

The menu 40 includes a text description 410 and control items 411-414. In the present embodiment, the menu 40 is integrated with control items of working modes and control items of other function modes of a handheld electronic device 30. The control items 411-414 respectively corresponds to a mute mode, a flight mode, a performance mode and power off, same as the menu displayed after a switch button is pressed longer than a preset period of time a handheld electronic device utilizing Android operating system developed by Google Inc., but with a new control item of performance/working mode selection.

When the user chooses the control item 413, the touch display panel unit 120 then displays a menu 41 as shown in FIG. 4B. The menu 41 includes a text description 421 and control items 422-424, wherein the control items 422-424 respectively corresponds to a high performance mode, a multimedia mode and a power saving mode, which are three working modes of a handheld electronic device 30. When the user chooses one of the three working modes (transmits the operating signal OS1 to the processor 110), the handheld electronic device 30 then switches working mode of the handheld electronic device according to the chosen control item.

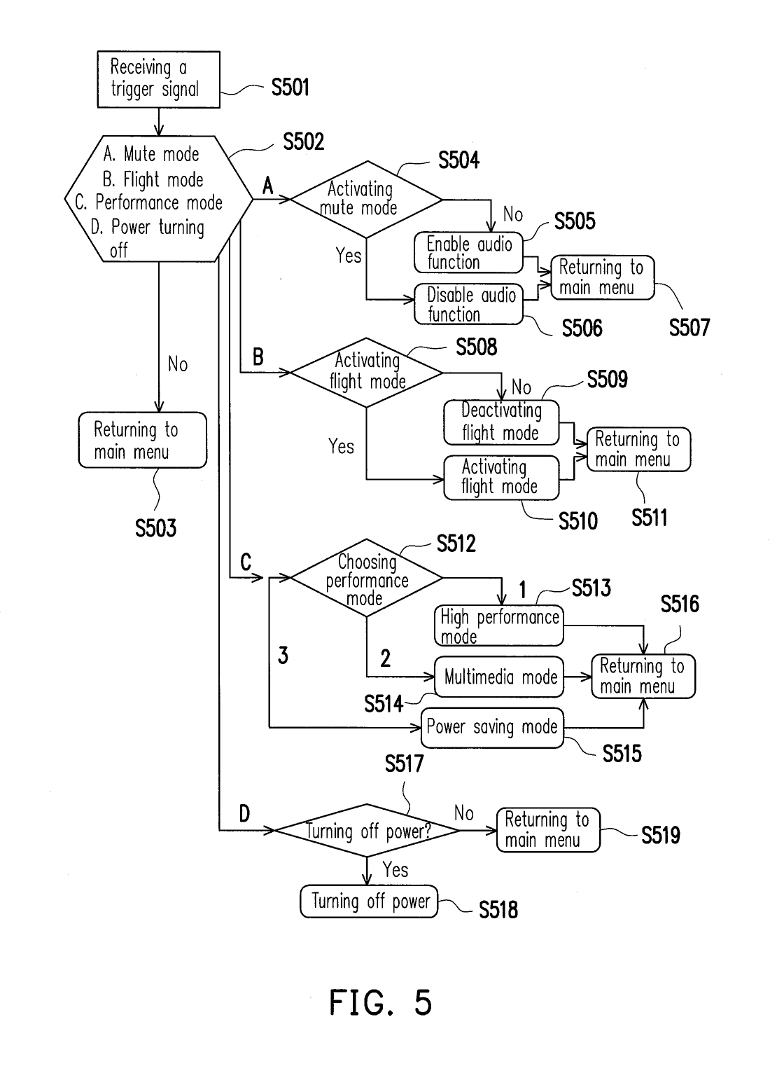

FIG. 5 is a flowchart illustrating a power saving method according to one embodiment of the invention, wherein the content of the embodiment shown in FIG. 5 corresponds to contents of the embodiments shown in FIG. 4A and FIG. 4B and includes control items other than control items for performing the power saving method. Referring to FIG. 3 and FIG. 5, after receiving a trigger signal such as pressing a physical button for a long time or receiving a specific audio from a microphone (Step S501), the processor 110 then controls touch display panel unit 120 to display menu 40 as shown in FIG. 4A in the touch display panel unit 120 (Step S502).

When the user chooses option A, which is an option of activating a mute mode, the processor 110 further determines if the user chooses to activate the mute mode (Step S504) through a operating signal OS3 transmitted by the touch display panel unit 120. If the user chooses to activate the mute mode, the processor 110 then disables a audio function (Step S506), and if the user chooses to turn off the mute mode, the processor 110 then enables/remains the audio function(Step S505). Next, a main menu of an user interface is displayed (Step S507).

When the user chooses option B, which is an option of activating a flight mode, the processor 110 further determines if the user chooses to activate a flight mode (Step S508) through the operating signal OS3 transmitted by the touch display panel unit 120. If the user chooses to activate the flight mode, the processor 110 then disables all communication functions (Step S510), and if the user chooses to turn off the flight mode, the processor 110 then enables/remains the communication functions (Step S509). Next, a main menu of the user interface is displayed (Step S511).

When the user chooses option C, which is an option of choosing a performance/working mode, the processor 110 determines if the user chooses one of the performance modes (Step S512) through the operating signal OS3 transmitted by the touch display panel unit 120. If the user chooses to switch to a high performance mode, the processor 110 then does not limit any computing performance of the processor 110 and other elements (Step S513). If the user chooses to switch to a multimedia mode, the processor 110 then limits the working frequency of the processor 110 and other elements to a first limit value, and/or turns off parts of processing cores in the processor (Step S514).

If the user chooses to switch to a multimedia mode, the processor 110 then limits the working frequency of the processor 110 and other elements to a second limit value, and/or turns off parts of computing cores in the processor (Step S515). Next, a main menu of the user interface is displayed (Step S516).

When the user chooses option D to turn off power of the handheld electronic device 30, the processor 110 determines if the user chooses to turn off power through the operating signal OS3 transmitted by the touch display panel unit 120 (Step S517). When the determination is positive, the processor 110 turns off the device (Step S518), and when the determination is negative, the processor 110 keeps the setting as original and displays the main menu of the user interface (Step S519).

It should be noted that the invention can be realized with application programs of a handheld electronic device and can also be embedded in an operating system of a handheld electronic device. For example, the embodiments in FIG. 4A and FIG. 4B show that an option of a performance mode (control item) is embedded in a menu in Android operating system of a handheld electronic device, wherein the menu is displayed when a switch button is pressed longer than a preset time. Since Android operating system is an operating system with an open source code, it is easier to realize an operating system by embedding control items of a performance mode into an originally preset menu than other close-source operating systems of smart phones.

Comparing to realizing the control items of the performance mode selection in a way of application programs, utilizing the control items of performance mode selection by embedding the control items in original operating system has higher compatibility with the system, which means less conflicts with the system itself and hardware of the handheld electronic device. In addition, manufacturers of handheld electronic devices can also prepare to test the function of selecting performance mode the handheld electronic device prior to shipments. Moreover, it is more convenient for a user to use an embedded preset menu to choose the performance/working mode without re-activating application programs each time the device is turned on.

Furthermore, in one embodiment of the invention, a count down unit is further disposed in the handheld electronic device. When a user leaves the handheld electronic device unused for more than a preset period of time, the count down unit transmits an operating signal to a processor regardless a original working mode of the handheld electronic device and switches the handheld electronic device from the original working mode to the power saving mode, so as to save power for the handheld electronic device in a more active way. Whether to implement the count down unit or not depends actual situations. The count down unit can be implemented by a hardware circuit, or it can also be realized with software functions, but the invention is not limited thereto.

In summary, the invention provides a power saving method and a handheld electronic device using the same, such that a working frequency of the handheld electronic device is limited when a user does not need higher computing capability to reach effects of saving power. Ways of limiting working frequency of a handheld electronic device include limiting the working frequency of a processor or turning off parts of processing cores. The user can adjust a working mode of the handheld electronic device by choosing from a menu of an user interface, and set a count down unit to automatically switch the working mode of the handheld electronic device to a power saving mode. Thus, power of the handheld electronic device can be consumed more efficiently and maximum using time of the handheld electronic device can be prolonged thereby.

Although the invention has been disclosed by the above embodiments, they are not intended to limit the invention. It will be apparent to people of ordinary skill in the art that modifications and variations to the invention may be made without departing from the spirit and the scope of the invention. Accordingly, the protection scope of the invention falls in the appended claims.

What is claimed is:

1. A power saving method, adapted for a handheld electronic device, wherein the handheld electronic device has a touch display panel unit, comprising:
receiving a trigger signal;
displaying an user interface in the touch display panel unit according to the trigger signal, wherein the user interface comprises at least one control item and the at least one control item respectively corresponds to at least one working mode of the handheld electronic device;
receiving an operating signal corresponding to one of the at least one control item from the touch display panel unit; and
switching the handheld electronic device to the corresponding working mode according to the operating signal and adjusting a working frequency of the handheld electronic device according to the working mode.

2. The power saving method of claim 1, wherein the at least one working mode comprises:
a high performance mode, a multimedia mode and a power saving mode, wherein when the handheld electronic device is switched to the multimedia mode, a highest processing frequency of a processor of the handheld electronic device is limited as a first limit value, and when the handheld electronic device is switched to the power saving mode, the highest processing frequency of the processor of the handheld electronic device is limited as a second limit value, wherein the first limit value is greater than the second limit value.

3. The power saving method of claim 1, wherein steps of receiving the trigger signal comprises:
receiving the trigger signal from an input/output unit of the handheld electronic device.

4. The power saving method of claim 3, wherein:
the input/output unit comprises a physical button.

5. The power saving method of claim 4, wherein:
the physical button is pressed for longer than a preset period of time.

6. The power saving method of claim 3, wherein steps of receiving the trigger signal comprises:
the input/output unit having a microphone.

7. The power saving method of claim 1, wherein the trigger signal is received by the touch display panel unit or a voice control operation.

8. A handheld electronic device, comprising:
a processor for receiving a trigger signal;
a touch display panel unit for displaying an user interface, wherein the user interface comprises at least one control item and the at least one control item respectively corresponds to at least one working mode of the handheld electronic device,
wherein the processor receives an operating signal corresponding to one of the at least one control item from the touch display panel unit, switches the working mode of the handheld electronic device according to the operating signal and adjusts a working frequency of the handheld electronic device according to the working mode.

9. The handheld electronic device of claim 8, wherein the at least one working mode comprises:
a high performance mode, a multimedia mode and a power saving mode, wherein when the processor switches the handheld electronic device to the multimedia mode, the processor limits a highest processing frequency of the processor as a first limit value, and when the processor switches the handheld electronic device to the power saving mode, the processor limits the highest processing frequency of the processor as a second limit value, wherein the first limit value is greater than the second limit value.

10. The handheld electronic device of claim 8, wherein the device further comprises:
an input/output unit, coupled to the processor.

11. The device of claim 10, wherein:
the input/output unit further comprises a physical button, wherein the processor receives the trigger signal from the physical button.

12. The device of claim 11, wherein:
when the physical button is pressed for longer than a preset period of time, the physical button transmits the trigger signal to the processor.

13. The device of claim 8, wherein the device further comprises:
the input/output unit having a microphone.

14. The device of claim 8, wherein:
the processor receives the trigger signal from the touch display panel unit or by a voice control operation.
